(19) United States
(12) Patent Application Publication
(10) Pub. No.: US 2016/0186880 A1
(43) Pub. Date: Jun. 30, 2016

(54) Solenoid Valve And Refrigeration Machine Which Uses Same

(71) Applicant: BSH HAUSGERÄTE GMBH, MUENCHEN (DE)

(72) Inventors: STEFAN BASSMANN, GIENGEN (DE); RAIK HEYNE, ILMENAU (DE); MANUEL SEITZ, OBENHAUSEN (DE)

(21) Appl. No.: 14/909,521

(22) PCT Filed: Jul. 24, 2014
(86) PCT No.: PCT/EP2014/065952

§ 371 Date: Feb. 2, 2016

(30) Foreign Application Priority Data
Aug. 2, 2013 (DE) 10 2013 215 261.2

(51) Int. Cl. F16K 31/06; F25B 41/04; F16K 31/08

(52) U.S. Cl. CPC F16K 31/0658; F16K 31/082; F25B 41/04

(57) ABSTRACT

A solenoid valve includes a valve seat and a closing body which can move under the influence of a magnetic field. The valve seat is crimped into a pipe.

The present invention relates to a solenoid valve, in particular for use in a refrigeration machine of a domestic refrigeration device, like for instance a chest freezer, a refrigerator etc.

Known solenoid valves, as described for instance in DE20122909U1, generally have a housing with an internal chamber, in which a closing body can be moved between at least one position which seals a valve seat and an open position under the influence of a magnetic field generated outside of the chamber. The chamber has a number of connections, which have to be soldered individually to refrigerant pipes upon installation of the solenoid valve into a refrigeration machine. Since the chamber has a larger diameter than the refrigerant pipes connected thereto and is also still loaded by an adjacently assembled coil, upon installation of the solenoid valve in a refrigeration device it is generally necessary to fasten the solenoid valve directly to the housing of the refrigeration device in order to ensure that it executes no vibrating movements which put strain on the connections to the refrigerant pipes. Such a direct fastening of the solenoid valve to the refrigeration device housing is nevertheless disadvantageous in that vibrations of the solenoid valve, which occur in particular when the closing body is attached to the valve seat, are transferred to the body. If the vibrations on the body find a suitable resonant surface, they can be heard as an interfering switching noise.

A solenoid valve is therefore needed, which can be installed in a refrigeration machine with little outlay.

The object is achieved in accordance with the invention by the valve seat being crimped into a pipe in the case of a solenoid valve having a valve seat and a closing body which can be moved under the influence of a magnetic field. A refrigerant pipe of a refrigeration machine can be used directly as a pipe so that the number of connections to be connected in a hermetically tight manner during installation of the solenoid valve is reduced.

The valve seat is generally crimped into the pipe not far from a connector end, by means of which it was originally inserted into the pipe. The pipe can extend freely across the closing body until it reaches another component of the refrigeration machine, like for instance an evaporator. Since the pipe is in one piece in this direction and is thus free of weak points, which could be worn out due to a vibrating movement of the solenoid valve, a mounting on this pipe can be arranged at a considerable distance from the solenoid valve so that the entire length of the pipe between the mounting and the solenoid valve is available in order to damp vibrations caused by the movement of the closing body before they can transfer onto the body of a device, in which the solenoid valve is installed. A reduction in the operating noise emission can also be achieved in this way with the inventive solenoid valve.

A permanent magnet, which defines a rest position of the closing body by means of magnetic attraction, is expediently accommodated in the pipe.

In particular, the valve seat can be arranged between the permanent magnet and the closing body, so that the rest position defined by the permanent magnet is a closing position of the valve, in which the closing body is fixedly held on the valve seat and seals the same.

In order to ensure quick and secure assembly of the solenoid valve, a main body is expediently provided, which is accommodated in the pipe and has a recess on a peripheral surface facing the pipe, into which recess part of the wall of the pipe can be pushed during assembly of the solenoid valve.

In order to facilitate this pushing of the pipe into the recess, it is expedient if the recess extends around the main body.

The main body can also support a peripheral sealing ring, in order to ensure that no refrigerant can pass between the main body and the surrounding wall of the pipe and the refrigerant flow can be completely blocked by placing the closing body on the valve seat.

If the main body is itself not the permanent magnet, it is preferably ferromagnetic, in order to act itself as a magnet under the influence of the permanent magnet and thus to securely fasten the closing body in a rest position, e.g. the closing position on the valve seat.

The valve seat is preferably one part, in particular a single-piece component, of the main body. It can however also be embodied on a component fastened for its part on the main body.

To ensure that the closing body, if it has been detached from the valve seat, can reach this again, its freedom of movement can be expediently restricted by a cage. According to one embodiment, the valve seat can be a component of this cage.

This cage is expediently connected to the valve seat to form a module, which, in a single work step, can be mounted as a unit in the pipe.

The cage can be tapered toward the valve seat in order to guide the closing body to the valve seat when the solenoid valve is closed.

A coil for generating the magnetic field can be arranged around the pipe. Such a design renders superfluous the pole shoe described in the prior art cited in the introduction for coupling the magnetic field of the coil into the pipe.

The permanent magnet can be arranged inside the coil and serve thus as an iron core for increasing the magnetic flux.

For the same purpose, the ferromagnetic base body can also be arranged inside the coil.

Depending on the electrical polarity, the coil can be operated in order to cancel the field of the permanent magnet and as a result to enable the closing body to be detached from the valve seat or to strengthen the magnetic field of the permanent magnet and thus attract the closing body to the valve seat.

The subject matter of the invention is also a refrigeration machine, in particular for domestic refrigeration devices, having at least one solenoid valve arranged in a refrigerant pipe as described above. The solenoid valve is preferably inserted into the refrigerant pipe such that the closing body is arranged upstream of the valve seat. The pressure of the refrigerant can thus carry the closing body away from the valve seat, if this is not fixed magnetically to the valve seat.

Further features and advantages of the invention become apparent from the description of exemplary embodiments below, with reference to the appended figures, in which:

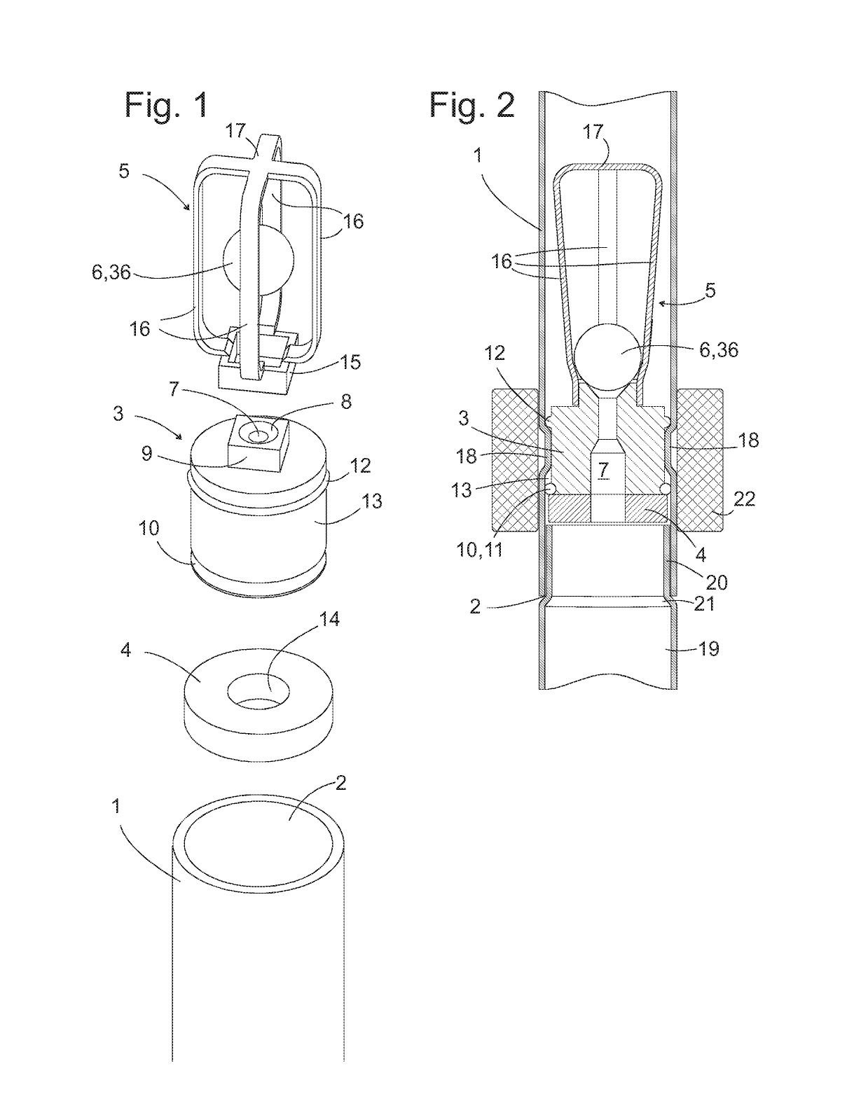

FIG. 1 shows an exploded perspective view of parts of a first inventive solenoid valve;

FIG. 2 shows a second inventive solenoid valve in the axial section;

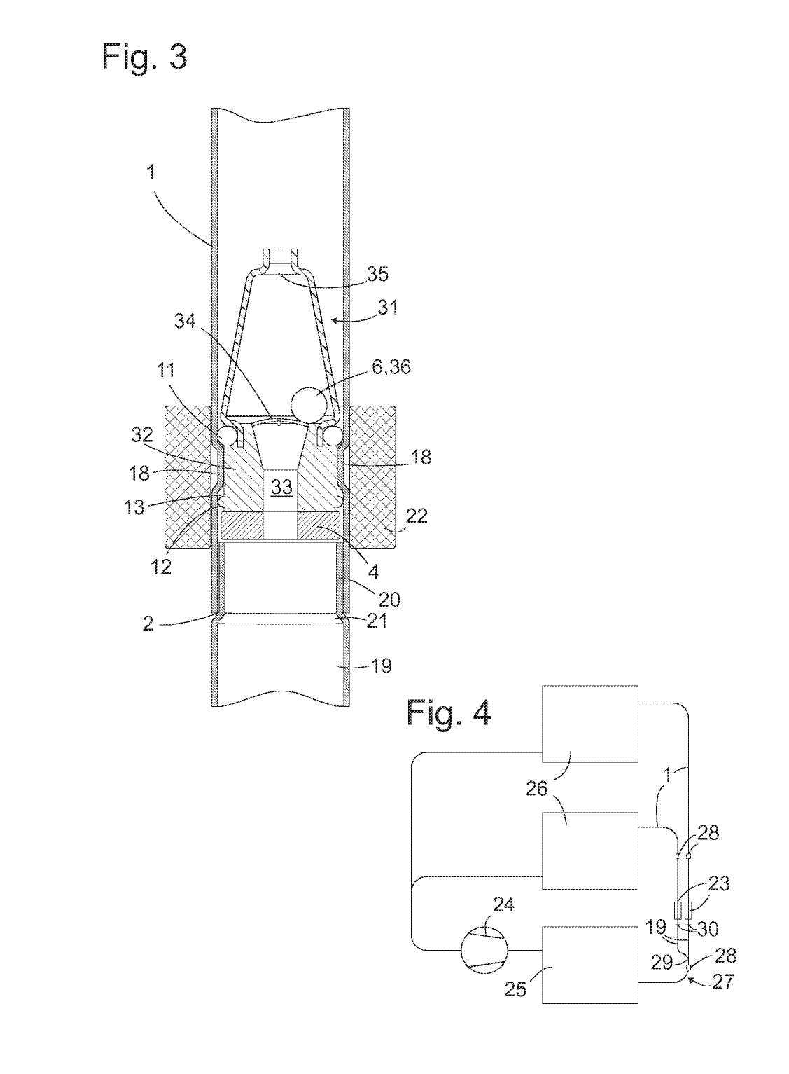

FIG. 3 shows a second inventive solenoid valve in the axial section; and

FIG. 4 shows a block diagram of a refrigeration machine equipped with solenoid valves according to FIG. 1, 2 or 3.

FIG. 1 shows an exploded view of parts of a solenoid valve according to the present invention. The solenoid valve comprises a pipe 1 made of copper or another easily deformable diamagnetic material. Only a short piece of the pipe 1 is shown in FIG. 1 with a connector opening 2, in practice the pipe 1 is significantly longer than the components of the solenoid valve to be mounted therein, such as: a main body 3, a permanent magnet 4, a cage 5 and a closing body 6 which can be moved in the cage 5, here a ball 36.

The main body 3 is a substantially cylindrical body made of ferromagnetic material, in particular iron, through which a bore 7 extends axially. The bore 7 leads to a cone-shaped valve seat 8 on the tip of a projection 9 protruding from a front face of the base body 3. A peripheral groove 10 on the periphery of the main body 3 is provided in order to accommodate an elastomer sealing ring 11 shown in FIG. 2. A recess 13 extends annularly around the base body 3 between this and a peripheral bulge 12.

The permanent magnet 4 is annular, with a continuous bore 14 which is aligned with the bore 7 of the main body 3. Means for mounting the permanent magnet 4 to the main body 3 are not provided, since both adhere to one another in a magnetically fixed manner.

The cage 5 has a foot piece 15 with an opening, which is molded so as to accommodate the projection 9 of the main body 3, and by crimping, soldering or suchlike be fastened to the projection 9. A number of braces 16 extend from the foot piece 15. The braces 16 substantially extend in the axial direction of the pipeline 1 and are connected in one piece at its ends facing away from the foot piece 15 by means of a cross 17. The distance between the braces 16 can be marginally larger than the diameter of the ball 36, so that this can be comfortably inserted into the cage 5 prior to insertion into the pipeline 1. After attaching the cage 5 in the pipeline 1, the ball 36 can no longer escape from the cage 5, since in the radial direction the passage between the braces 16 is blocked by the pipe 1 and in the axial direction the free cross-section between the arms of the cross 17 is not sufficient.

FIG. 2 shows a completely assembled solenoid valve in an axial longitudinal section. In order to assemble the valve as shown in the Figure, the sealing ring 11 is firstly positioned in the groove 10 of the main body 3, and the main body 3 is connected with the cage 5 and the permanent magnet ring 4 to form a module. This module is inserted into the pipeline 1 by way of its connector opening 2. Since the sealing ring rests over the entire periphery on the wall of the pipe 1, the module is provisionally fixed in the pipe 1 in a frictionally engaged manner.

The module can be inserted into the pipe 1 both preceded with the permanent magnet 4 and also, as shown in FIG. 2, preceded with the cage 5. The last orientation is preferred since if for insertion purposes no pressure has to be exerted on the cage 5, this can be embodied in a light and thin-walled manner. A further advantage of this orientation is that when the pipe 1 is assembled with a second pipe 19, a tapered section 20 of the latter can strike a solid component of the module, here the permanent magnet 4 during insertion into the pipe 1 and can push the module along during further insertion. If the tapered section 20 is inserted completely into the pipe 1, such that a shoulder 21 of the pipe 19 strikes the connector opening 2, the recess 13 is disposed at a fixed, known distance from the connector opening 2. At this known distance from the connector opening 2, pliers can now be positioned on the pipe 1, in order to mold the notches 18 engaging in the recess 13 and to fix the module in the pipeline 1.

A coil 22 is slid onto the pipe 1 prior to insertion of the pipes 1, 19. The coil 22 is fastened to the pipe 1 in a position in which it covers the notches 18. It thus overlaps axially with the valve seat 3, and in the case shown here, also with the permanent magnet 4, so that both of the coils 22 can be used as iron core. This dual function of the valve seat 3 and permanent magnet 4 saves on weight and installation space.

If the coil 22 is energized, it generates an axially oriented magnetic field in the pipeline 1, which is in parallel or antiparallel to the field of the permanent magnet 4 depending on the direction of the current. If the antiparallel field compensates for the field of the permanent magnet 4, the ball 36 is no longer exposed to a magnetic force of attraction and can be pushed out of its rest position on the valve seat 8 by the refrigerant present in the pipe 19. The open position of the solenoid valve thus reached can also remain in the unenergized state of the coil 22, if the flow of the refrigerant is sufficiently strong to keep the ball 36 remote from the main body 3 and the field of the permanent magnet 4 which is effective there.

If by contrast the coil 22 is energized in the opposite direction, its magnetic field and that of the permanent magnet 4 then strengthen mutually, the ball 36 is drawn to the valve seat 8 and seals this again.

In order to quickly close the valve, the ball 36 is to strike the valve seat 8 as centrally as possible. As shown in FIG. 2, this is facilitated by a form of the cage 5 which tapers toward the valve seat 8.

FIG. 3 shows an axial section through a further inventive solenoid valve which is similar to FIG. 2. Components which already correspond to components described with reference to FIG. 1 or FIG. 2 bear the same reference characters as there and are not explained again. Contrary to the cage 5, between the braces 16 of which the refrigerant can flow through freely and which only restrict the freedom of movement of the closing body 6 embodied in turn as a ball 36, a closed-wall cage 31 made of non-magnetic material is provided here. An inlet opening of the cage 31 is fastened to a ferromagnetic main body 32, which is surrounded by the coil 22 outside of the pipe 1. The main body 32 has a spacious passage 33, which cannot be closed by the ball 36. A blocker, here in the form of two intersecting braces 34, prevents the ball 36 from intruding into the passage 33 under the influence of the permanent magnet 4. An outlet opening of the cage 31 which faces the inlet opening forms a valve seat 35.

In the open position shown, the ball 36 is held by the permanent magnet 4 remote from the passage 33 in contact with the ferromagnetic main body 32. In order to close the valve, the coil 22 is applied with a current pulse, which generates a magnetic field opposing the magnetic field of the permanent magnet 4 in the main body 32. The ball 36 is as a result no longer held on the main body 32 and is entrained by the flow of the refrigerant until it reaches the valve seat 35 and closes the valve.

If by contrast the coil is applied with a current pulse with an opposite sign, then the resulting magnetic field is oriented in the same direction as that of the permanent magnet. The magnetic force acting on the ball 36 is now sufficient to detach the ball 36 from the valve seat 35 and open the valve again.

FIG. 4 shows a schematic representation of a refrigeration machine, which uses solenoid valves 23 of the type described above. The refrigeration machine customarily comprises a compressor 24, a condenser 25 connected to the pressure output of the compressor 24 and two evaporators 26 which are parallel to one another and connected to the output of the condenser by way of a branching refrigerant pipe 27, said evaporators 26 cooling different compartments, for instance a normal refrigerator compartment and a freezer compartment, of a combination refrigeration device. The refrigerant pipe 27 comprises two pipes 19, which extend from the branching 29 to just before the solenoid valves 23. Pipes 19 are plug-connected and soldered with pipes 1 at points 30, into which the modules of the valves 23 are inserted and which extend in one piece continuously to the evaporators 26.

The refrigerant pipe 27 is fixed to the housing of the refrigeration device at several points, for instance by pipe brackets 28. The solenoid valves 23 are arranged in the two branches of the refrigerant pipe 27 in each case at a distance from the pipe brackets 28, so that the sections of the pipe 27 disposed between the pipe brackets 28 and accommodating the valves 23 are able to vibrate to a certain degree and are as a result able to damp vibrations developing when the valves 23 are switched before these reach the pipe brackets 28 and can cause the body to vibrate.

### REFERENCE CHARACTERS

| | |
|---|---|
| 1 | pipe |
| 2 | connector opening |
| 3 | main body |
| 4 | permanent magnet |
| 5 | cage |
| 6 | closing body |
| 7 | bore |
| 8 | valve seat |
| 9 | projection |
| 10 | groove |
| 11 | sealing ring |
| 12 | bulge |
| 13 | recess |
| 14 | bore |
| 15 | foot piece |
| 16 | brace |
| 17 | cross |
| 18 | notch |
| 19 | pipe |
| 20 | section |
| 21 | shoulder |
| 22 | coil |
| 23 | solenoid valve |
| 24 | compressor |
| 25 | condenser |
| 26 | evaporator |
| 27 | refrigerant pipe |
| 28 | pipe bracket |
| 29 | branching |
| 30 | point |
| 31 | cage |
| 32 | main body |
| 33 | passage |
| 34 | brace |
| 35 | valve seat |
| 36 | ball |

1-15. (canceled)

16. A solenoid valve for a refrigeration machine, the solenoid valve comprising:
a pipe guiding refrigerant;
a valve seat crimped into said pipe;
a cage connected to said valve seat to form a module, said cage being tapered toward said valve seat; and
a closing body being movable in said cage under an influence of a magnetic field.

17. The solenoid valve according to claim 16, which further comprises a permanent magnet accommodated in said pipe.

18. The solenoid valve according to claim 17, wherein said valve seat is disposed between said permanent magnet and said closing body.

19. The solenoid valve according to claim 16, which further comprises a main body accommodated in said pipe, said main body having a peripheral surface facing said pipe and said peripheral surface having a recess into which said pipe is pressed.

20. The solenoid valve according to claim 19, wherein said recess extends annularly around said valve seat.

21. The solenoid valve according to claim 19, which further comprises a peripheral sealing ring carried by said main body.

22. The solenoid valve according to claim 19, wherein said main body is ferromagnetic.

23. The solenoid valve according to claim 19, wherein said valve seat is part of said main body.

24. The solenoid valve according to claim 16, which further comprises a coil disposed around said pipe for generating the magnetic field.

25. The solenoid valve according to claim 24, which further comprises a permanent magnet accommodated in said pipe and disposed inside said coil.

26. The solenoid valve according to claim 24, which further comprises a ferromagnetic main body accommodated in said pipe and disposed inside said coil, said main body having a peripheral surface facing said pipe and said peripheral surface having a recess into which said pipe is pressed,

27. A refrigeration machine, comprising:
a refrigerant pipe; and
at least one solenoid valve according to claim 16 disposed in said refrigerant pipe.

28. The refrigeration machine according to claim 27, wherein said closing body is disposed downstream of said valve seat.

29. The refrigeration machine according to claim 27, wherein the refrigeration machine is part of a domestic refrigeration device.
